(19) United States
(12) Patent Application Publication
(10) Pub. No.: US 2026/0356500 A1
(43) Pub. Date: Nov. 12, 2026

(54) Collaborative Controlled Electromagnetic Deflection of Space Objects

(71) Applicant: International Business Machines Corporation, Armonk, NY (US)

(72) Inventors: Sarbajit Kumar RAKSHIT, Kolkata (IN); Sridevi KANNAN, Chennai (IN); Sathya SANTHAR, Chennai (IN)

(21) Appl. No.: 19/199,902

(22) Filed: May 6, 2025

(51) Int. Cl. B64G 1/24; B64G 1/10; B64G 1/56; B64G 3/00; G05D 1/639; G05D 109/40

(52) U.S. Cl. CPC B64G 1/244; B64G 1/1085; B64G 1/242; B64G 1/56; B64G 3/00; G05D 1/642; G05D 2109/40

(57) ABSTRACT

In some implementations, a computer system may identify a predicted collision between space objects. The computer system may determine a collaborative deflection strategy for deflecting at least one of the space objects to avoid the predicted collision, the collaborative deflection strategy including deflections by a plurality of satellites equipped with respective electromagnetic deflection modules. The computer system may control the plurality of satellites to deflect the at least one of the space objects in accordance with the collaborative deflection strategy.

### BACKGROUND

This disclosure relates to collision avoidance for space objects.

### SUMMARY

Some aspects described herein relate to a method. The method may include identifying a predicted collision between space objects. The method may include determining a collaborative deflection strategy for deflecting at least one of the space objects to avoid the predicted collision, the collaborative deflection strategy including deflections by a plurality of satellites equipped with respective electromagnetic deflection modules. The method may include controlling the plurality of satellites to deflect the at least one of the space objects in accordance with the collaborative deflection strategy.

Some aspects described herein relate to a computer system. The computer system may include a processor set, one or more computer-readable storage media, and program instructions stored on the one or more computer-readable storage media to cause the processor set to perform operations. The operations may include identifying a predicted collision between space objects. The operations may include selecting a plurality of satellites, each equipped with a respective electromagnetic deflection module, to deflect the at least one of the space objects to avoid the predicted collision. The operations may include determining a collaborative deflection strategy for deflecting the at least one of the space objects by the plurality of satellites to avoid the predicted collision. The operations may include controlling the plurality of satellites to deflect the at least one of the space objects in accordance with the collaborative deflection strategy.

Some aspects described herein relate to a computer program product. The computer program product may include one or more computer-readable storage media and program instructions stored on the one or more computer-readable storage media to perform operations. The operations may include identifying a predicted collision between space objects. The operations may include selecting a plurality of satellites equipped with respective electromagnetic deflection modules for deflecting at least one of the space objects to avoid the predicted collision. The operations may include controlling the plurality of satellites to deflect the at least one of the space objects in accordance with a collaborative deflection strategy.

### BRIEF DESCRIPTION OF THE DRAWINGS

FIG. 1 is a diagram of an example computing environment for collaborative controlled electromagnetic deflection of space objects as described herein.

FIGS. 2A-2B are diagrams of an example implementation associated with collaborative controlled electromagnetic deflection of space objects.

FIG. 3 is a flowchart of an example process associated with collaborative controlled electromagnetic deflection of space objects.

FIG. 4 is a flowchart of an example process associated with collaborative controlled electromagnetic deflection of space objects.

FIG. 5 is a flowchart of an example process associated with collaborative controlled electromagnetic deflection of space objects.

### DETAILED DESCRIPTION

The following detailed description of example implementations refers to the accompanying drawings. The same reference numbers in different drawings may identify the same or similar elements.

In space, satellites and other space objects, including space debris, are in constant orbit around the Earth. “Space object” refers to any object that is in orbit around the Earth or another celestial body. For example, space objects may include satellites of various sizes (e.g., including spacecraft in orbit around the Earth) or space debris. Space debris may include defunct or non-functional satellites that are no longer in use, spacecraft launch vehicle components that are no longer in use, fragmented pieces of satellites or other objects that have broken apart (e.g., due to collisions, explosions, or other events), small objects such as bolts, screws, paint chips, and other fragments that have come loose from spacecraft, satellites, or other objects, and/or other non-functional man-made objects that are in orbit around the Earth. The risk of collision between these objects is significant, as the speed at which they travel can result in catastrophic consequences upon impact. A collision between a satellite and another space object (e.g., space debris or another satellite) can result in the damage or destruction of the satellite, which can be extremely expensive to replace or repair and can disrupt valuable services such as navigation, communication, and weather forecasting, among other examples. Furthermore, collisions between space objects (e.g., space debris and/or satellites) can generate additional space debris, which can range from small fragments to large pieces of wreckage, and the additional space debris can potentially cause further collisions. Collisions between space objects also pose a risk to human spaceflight missions.

Currently, larger satellites are equipped with maneuvering modules, which enable them to change their orbital path to avoid collisions. However, maneuvering such satellites typically has a high cost and consumes a large amount of energy and/or other resources (e.g., processing resources, memory resources, network resources, and/or the like). Furthermore, smaller satellites and space debris lack this maneuvering capability, and therefore cannot be controlled to perform maneuvers to avoid potential collisions. Moreover, the amount of space debris in Earth's orbit is increasing, making collision avoidance even more challenging, particularly for potential collisions between small satellites or between small satellites and space debris.

Some implementations described herein provide a method, performed by a computer system, for collaborative controlled electromagnetic deflection of space objects to avoid collision in space. The computer system may identify a predicted collision between space objects. The computer system may determine a collaborative deflection strategy for deflecting at least one of the space objects to avoid the predicted collision, and the collaborative deflection strategy may include deflections by a plurality of satellites equipped with electromagnetic deflector modules. In some aspects, the computer system may select the plurality of satellites to deflect at least one of the space objects based on relative positions of the plurality of satellites and the space objects in a simulation of orbital trajectories of the plurality of satellites and the space objects. The computer system may control the plurality of satellites to deflect the at least one of the space objects in accordance with the collaborative deflection strategy. For example, the computer system may transmit control signals to the plurality of satellites to activate the respective electromagnetic deflection modules of the plurality of satellites to deflect at least one of the space objects in accordance with the collaborative deflection strategy.

In this way, collisions between space objects may be avoided, even in scenarios in which the space objects do not have maneuvering capabilities (e.g., collisions between two small satellites or collisions between space debris and a small satellite). As a result, collisions between space objects are reduced, resulting in reduced costs for replacing or repairing damaged satellites, reduced disruption to satellite services, reduced risk of additional collisions, and reduced risk to human spaceflight missions. Furthermore, avoiding a potential collision between space objects by controlling the plurality of satellites to deflect at least one space object may reduce costs, reduce energy consumption, and conserve resources (e.g., processing resources, memory resources, network resources, and/or the like) as compared with maneuvering a satellite to avoid a collision.

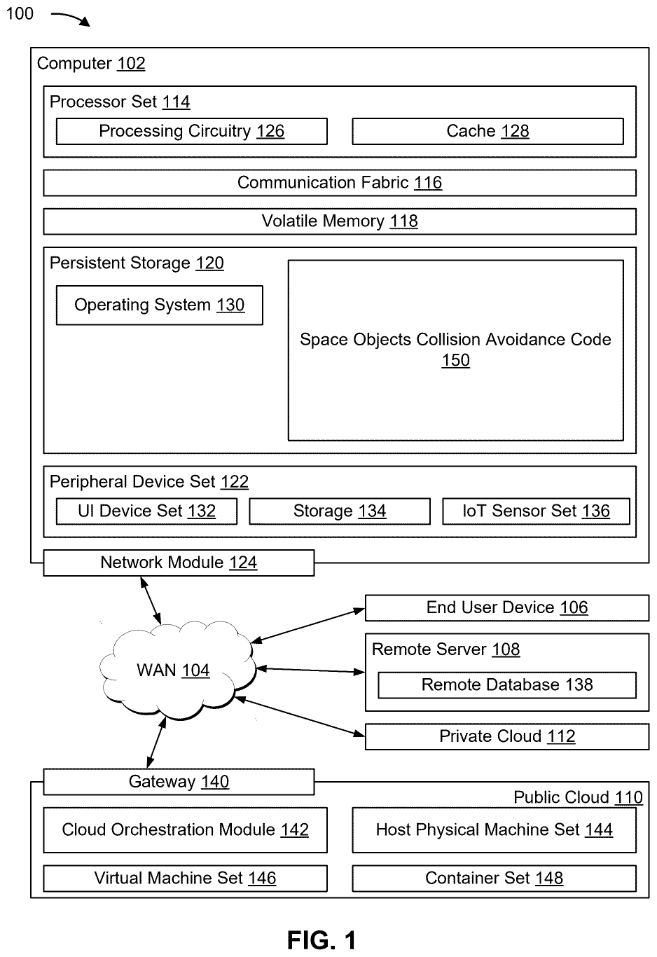

FIG. 1 is a diagram of an example computing environment 100 for collaborative controlled electromagnetic deflection of space objects as described herein.

The computing environment 100 contains an example of an environment for the execution of at least some of the computer code involved in performing the inventive methods, such as space objects collision avoidance code 150. In addition to the space objects collision avoidance code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the space objects collision avoidance code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in the space objects collision avoidance code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input/output ports, among other examples. Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The code included in the space objects collision avoidance code 150 typically includes at least some of the computer code involved in performing one or more operations described herein.

In some implementations, the operations may include identifying a predicted collision between space objects; determining a collaborative deflection strategy for deflecting at least one of the space objects to avoid the predicted collision, the collaborative deflection strategy including deflections by a plurality of satellites equipped with respective electromagnetic deflection modules; and controlling the plurality of satellites to deflect the at least one of the space objects in accordance with the collaborative deflection strategy.

In some implementations, the operations may include identifying a predicted collision between space objects; selecting a plurality of satellites, each equipped with a respective electromagnetic deflection module, to deflect the at least one of the space objects to avoid the predicted collision; determining a collaborative deflection strategy for deflecting the at least one of the space objects by the plurality of satellites to avoid the predicted collision; and controlling the plurality of satellites to deflect the at least one of the space objects in accordance with the collaborative deflection strategy.

In some implementations, the operations may include identifying a predicted collision between space objects; selecting a plurality of satellites equipped with respective electromagnetic deflection modules for deflecting at least one of the space objects to avoid the predicted collision; and controlling the plurality of satellites to deflect the at least one of the space objects in accordance with a collaborative deflection strategy.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1 is provided as an example. Other examples may differ from what is described with regard to FIG. 1.

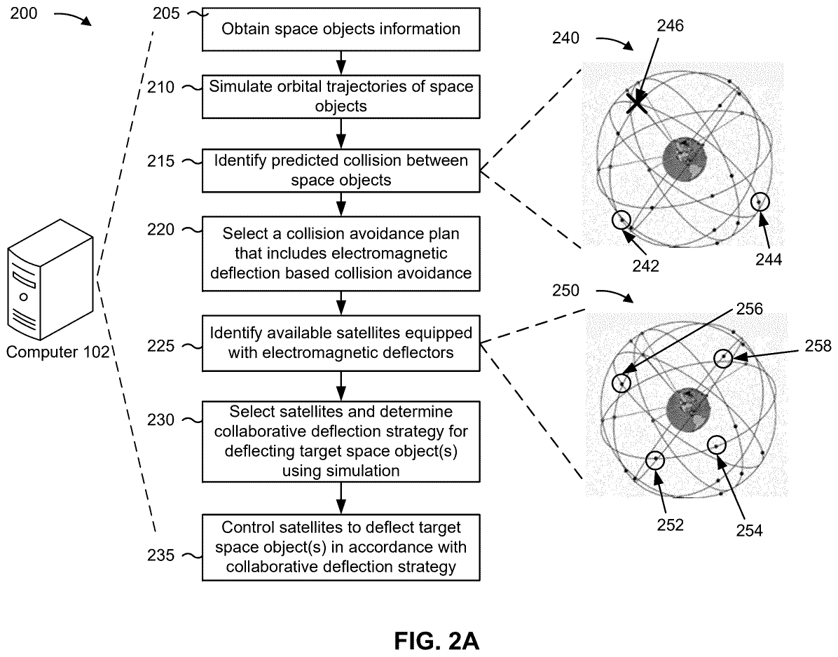

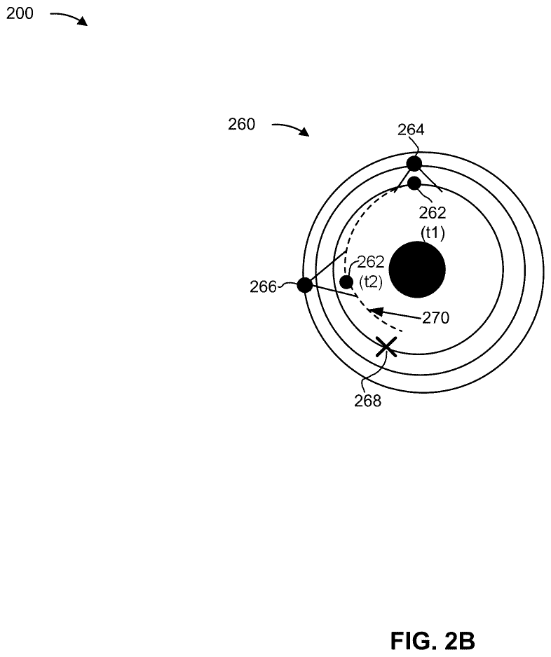

FIGS. 2A-2B are diagrams of an example implementation 200 associated with collaborative controlled electromagnetic deflection of space objects. As shown in FIG. 2A, example implementation 200 includes a computer system (e.g., computer 102). In some aspects, the computer system (e.g., computer 102) may be a space traffic management system. “Space object” refers to any object that is in orbit around the Earth or another celestial body. For example, space objects may include satellites of various sizes (e.g., including spacecraft in orbit around the Earth) or space debris. In example implementation 200, the space objects are described as orbiting the Earth. However, the operations of the computer system described in connection with example implementation 200 may be similarly applied for space objects orbiting around any celestial body.

As shown in FIG. 2A, and by reference number 205, the computer system may obtain space objects information. The space objects information may include information associated with a plurality of space objects orbiting the Earth. The information may identify each space object of the plurality of space objects and a respective orbital position of each space object of the plurality of space objects. In some implementations, the plurality of space objects may include all known or detected space objects orbiting the Earth. The plurality of space objects may include satellites of various sizes and space debris. In some examples, the information may also include orbital path information for the space objects and/or relative orbital positions of different space objects in different orbits. In some implementations, the computer system may obtain some or all of the information associated with the space objects by tracking the space objects. For example, the computer system may track the orbits of satellites and space debris. In some examples, the computer system may detect (and then track the orbits of) previously unknown space debris. In some other implementations, the computer system may obtain some or all of the information associated with the space objects from other systems (e.g., other computer systems or space object tracking systems) that track satellites and space debris.

In some implementations, the information associated with the space objects may identify a type of each space object. For example, each space object may be a satellite or space debris (e.g., a piece of space debris). For the space debris, the information may also indicate a size of each of the space objects that are space debris (e.g., a size of the piece of space debris). For the satellites, the information may indicate size, a maneuvering capability, and/or an electromagnetic deflection capability for each satellite. The maneuvering capability for a satellite may identify whether the satellite is equipped with a maneuvering module or not. A maneuvering module is a system (e.g., a propulsion system) that enables maneuvering of the satellite (for example, to switch an orbital path of the satellite). The electromagnetic deflection capability for a satellite may identify whether the satellite is equipped with an electromagnetic deflection module. An electromagnetic module is a system that enables a satellite to generate an electromagnetic force (e.g., by emitting an electromagnetic wave) that can deflect another space object. For example, the electromagnetic module of a satellite may include an electromagnetic coil for emitting an electromagnetic wave.

As further shown in FIG. 2A, and by reference number 210, the computer system may simulate orbital trajectories of the space objects. For example, the computer system may simulate the orbital trajectories of the plurality of space objects based on the information associated with the plurality of space objects (e.g., the space objects information). In some implementations, the computer system may perform a simulation of future orbital trajectories for the plurality of space objects based on the orbital positions (e.g., current orbital positions) of the plurality of space objects and/or the trajectory path information for the plurality of space objects.

As further shown in FIG. 2A, and by reference number 215, the computer system may identify a predicted collision between space objects based on the simulation. For example, the computer system may identify a predicted collision between space objects based on the simulated orbital trajectories of the space objects. In some implementations, the computer system may determine/predict a collision risk of a collision between two space objects (e.g., a first space object and a second space object) based on the simulated orbital trajectories of the space objects. For example, the risk of a collision between the first space object and the second space object may be a collision probability determined based on a distance between the first space object and the second space object at a given time in the simulation of orbital trajectories. In some implementations, the computer system may identify a predicted collision between the first space object and the second space object in connection with whether the risk of collision between the first space object and the second space object satisfies (e.g., reaches or exceeds) a risk threshold. The computer system, in connection with identifying the predicted collision between the first and second space objects, may also identify a time at which the collision is predicted to occur and an orbital position at which the collision is predicted to occur. For example, the time for the predicted collision may be a simulated time at which the predicted collision is identified, and the orbital position for the predicted location may be the orbital position, on the simulated orbital trajectories, at which the predicted collision is identified.

FIG. 2A shows an example 240 of a predicted collision between space objects. As shown in example 240, the computer system predicts that a collision will occur between a first space object 242 and a second space object 242 based on the simulation of the orbital trajectories of the plurality of space objects. The computer system, based on the simulation, also identifies a time and an orbital position (shown by reference number 246) at which the collision between the first space object 242 and the second space object 242 is expected to occur.

As further shown in FIG. 2A, and by reference number 220, the computer system may select a collision avoidance plan that includes electromagnetic deflection based collision avoidance. In some implementations, the computer system, in connection with identifying a predicted collision between space objects (e.g., between a first space object and a second space object), may determine whether to use electromagnetic deflection based collision avoidance to avoid (e.g., prevent) the predicted collision between the space objects. For example, the computer system may determine whether the predicted collision is a suitable candidate for collision avoidance using electromagnetic deflection (e.g., collaborative electromagnetic deflection by multiple satellites equipped with electromagnetic deflection modules).

In some implementations, the computer system may determine a collision avoidance plan to avoid (e.g., prevent) the predicted collision between the space objects. In such implementations, the computer system may determine whether the collision avoidance plan includes electromagnetic deflection (e.g., collaborative electromagnetic deflection) of at least one target space object (e.g., at least one of the space objects for which the collision is predicted). In some implementations, the computer system may determine whether to use electromagnetic deflection based collision avoidance (e.g., whether electromagnetic deflection avoidance is included in the collision avoidance plan) for a predicted collision between space objects based on the types (e.g., space debris or satellite) of the space objects, sizes of the space objects, maneuvering capabilities of the space objects (for space objects that are satellites), orbital positions of the space objects, a collision type (or degree of collision) of the predicted collision, or costs associated with selecting the electromagnetic deflection based collision avoidance or another technique (e.g., maneuvering a satellite) for collision avoidance. For example, based on one or more of the above considerations, the computer system may determine/select a collision avoidance plan that includes electromagnetic deflection of one space object (e.g., the first space object or the second space object) of the space objects for which the collision is predicted, electromagnetic deflection of both space objects (e.g., the first space object and the second space object) for which the collision is predicted, satellite maneuvering based collision avoidance without electromagnetic deflection of the space objects, or a combination of electromagnetic deflection and satellite maneuvering (e.g., electromagnetic deflection of one of the space objects and satellite maneuvering of the other one of the space objects).

In some implementations, the computer system may identify the collision type (or collision degree) for the predicted collision based on the simulation of the orbital trajectories. For example, the type of the collision may be a “slightly touching” collision or a “head-to-head” collision. The computer system may also estimate the impact of the predicted collision based on the simulation. In some examples, the computer system may select to use electromagnetic deflection based collision avoidance for a “slightly touching” type collision and/or for a lower impact collision.

In some implementations, the computer system may select the type of collision avoidance based at least in part on the types of the space objects for which the collision is predicted, a comparison of sizes (or dimensions) of the space objects, and/or the capabilities of the space objects (e.g., for the satellite space objects). Larger satellites may be equipped with maneuvering modules, and electromagnetic deflection may be more effective on smaller space objects than on larger satellites. In some examples, in a case in which the predicted collision is between two larger satellites, with at least one of the satellites having a maneuvering module, the computer system may select a collision avoidance plan that uses maneuvering of at least one of the satellites. In some examples, in a case in which the collision is between a piece of space debris and a smaller satellite without a maneuvering module or between two smaller satellites without maneuvering modules, the computer system may select a collision avoidance plan that includes electromagnetic deflection of one or both of the space objects predicted to collide. In some examples, such as for a predicted collision between a piece of space debris or a smaller satellite and a larger satellite (e.g., with a maneuvering module), the selection of the collision avoidance plan may be based on the impact of the collision and/or a comparison of a cost associated with the electromagnetic deflection and a cost associated with maneuvering a satellite, among other examples. In some implementations, the computer system may estimate the cost of collision avoidance by maneuvering one or more satellites, estimate the cost of the electromagnetic deflection based collision avoidance, and select the collision avoidance plan based on a comparison of the estimated cost for maneuvering the one or more satellites and the estimated cost for the electromagnetic deflection.

As further shown in FIG. 2A, and by reference number 225, the computer system may identify available satellites equipped with electromagnetic detectors that can be controlled to deflect at least one target space object. The computer system may identify a set of satellites that are equipped with electromagnetic deflection modules and are available for collaborative deflection of at least one target space object (e.g., at least one of the space objects for which the collision is predicted) based on the simulation of the orbital trajectories. For example, the computer system may identify multiple satellites available for collaborative electromagnetic deflection of the target space objects based on relative positions of the satellites and the target space objects in the simulation of orbital trajectories. In this case, the computer system may determine which satellites, that are equipped with electromagnetic deflector modules, will be near the target space objects in a timeframe preceding the predicted collision. For example, based on the simulation results, the computer system may identify which satellites in different angular orbital paths from a target space object will be near the space object in a timeframe preceding the predicted collision.

FIG. 2A shows an example 250 of identifying available satellites that can be controlled for collaborative deflection of one or more target space objects. As shown in example 250, the computer system identifies a set of satellites 252, 254, 256, and 258 that are equipped with electromagnetic deflector modules and will be at orbital positions near at least one of the first space object 242 or the second space object 244 (shown in example 240) in a timeframe prior to the predicted collision between the first space object 242 or the second space object 244.

As further shown in FIG. 2A, and by reference number 230, the computer system may select satellites to deflect at least one target space object and determine a collaborative deflection strategy for the satellites using simulation of the deflection of the at least one target space object. The collaborative deflection strategy may include deflections of at least one target space object by multiple satellites equipped with respective electromagnetic deflection modules. The computer system may determine, based on the simulation of the deflection of a target space object, how many satellites, of the satellites available for collaborative deflection of the target space object, are to be used to achieve a target deflection for the target space object to avoid the predicted collision. The computer system may also select which of the satellites available for collaborative deflection of the target space object to use to perform the collaborative deflection of the target space object.

The collaborative deflection strategy may include, for each of the satellites selected for the collaborative deflection of a target space object, a timing for activating the electromagnetic deflector module of the satellite and an electromagnetic power (e.g., electromagnetic force) to be applied by the electromagnetic deflector module for the deflection of the target space object by the satellite. In some implementations, the computer system may determine a target deflection for deflecting the target space object to avoid the predicted collision, and the computer system may determine the timing and the electromagnetic power of the respective deflection of the target by each of the plurality of satellites. For example, the target deflection for deflecting the target space object may be a total target deflection for the space object to avoid the predicted collision, and the computer system may determine, using simulations of the deflection of the target space object, respective incremental target deflections associated with the multiple selected satellites. In this case, the computer system may determine the respective incremental target deflections associated with the satellites to achieve the total target deflection. For example, the total target deflection may be a sum of the respective incremental deflections associated with the satellites. The computer system may then determine, based on the respective incremental target deflections associated with the satellites, the timing and the electromagnetic power (e.g., electromagnetic force) for reflecting the target space object by each of the satellites. In some examples, the computer system may determine the electromagnetic power (e.g., electromagnetic force) and the timing (e.g., a time at which the electromagnetic deflector module is to be activated and a duration for which the electromagnetic deflector module is to stay activated) for each satellite to achieve the respective incremental target deflection of the target space object based on a simulated distance between the satellite and the target space object at the time of the deflection. The computer system may determine, using simulations of the deflection of the target space object, the timeframe, preceding the predicted collision, for collaborative deflecting of the target space object by the selected satellites.

In some aspects, the computer system may simulate the deflection of one or more target space objects in accordance with the collaborative deflection strategy, and may simulate an effect of the deflection of the one or more target space objects on potential collisions with other space objects of the plurality of space objects. For example, the computer system may simulate the deflection of a target space object and then simulate the resulting trajectory of the target space object and orbital trajectories of other nearby space objects to predict whether the deflection will cause any additional collisions. The computer system may adjust the collaborative deflection strategy in connection with determining or predicting, based on the simulation, that the deflection of the target space object will result in one or more additional collisions. In this case, the computer system may determine that the collaborative deflection strategy is a final collaborative deflection strategy for avoiding the predicted collision in connection with determining, based on the simulation, that the collaborative deflection strategy achieves the target deflection of the target space object to avoid the predicted collision and the collaborative deflection strategy does not cause any additional collisions between space objects.

In some implementations, the computer system may determine a collaborative deflection strategy that uses collaborative deflection of a target space object by multiple satellites to deflect the target space object out of orbit and into an atmosphere of the Earth. In this case, the collaborative deflection strategy may include a sequence of deflections by multiple satellites to deflect the target space object into the atmosphere of the Earth. For example, the computer system may determine the collaborative deflection strategy that deflects a piece of space debris into the atmosphere of the Earth so that the piece of space debris will burn up in the atmosphere and no longer be able to collide with another space object. The computer system may also calculate, based on the simulation and/or characteristics of the target space object, whether the target space object will burn up in the atmosphere. In some implementations, the computer system may determine a collaborative deflection strategy that uses collaborative deflection of a target space object by multiple satellites to deflect the target space object out of orbit and into space (e.g., away from Earth). In this case, the collaborative deflection strategy may include a sequence of deflections by multiple satellites to deflect the target space to no longer orbit the Earth and drift into outer space.

As further shown in FIG. 2A, and by reference number 235, the computer system may control the satellites to deflect at least one target space object in accordance with the collaborative deflection strategy. In some implementations, the computer system may control the satellites selected for the collaborative deflection by transmitting control signals to the satellites that cause the satellites to deflect the at least one target space object in accordance with the collaborative deflection strategy. In some examples, the computer system may transmit control signals (or commands) to the satellites to activate respective electromagnetic deflection modules of the satellites in accordance with the collaborative deflection strategy. For example, the computer system may transmit, to each satellite of the multiple satellites selected for the collaborative deflection of a target space object, a control signal (or command) that controls the satellite to activate the electromagnetic deflector module in accordance with the timing and electromagnetic power in the collaborative deflection strategy for the satellite. In this way, the computer system may control each satellite to achieve the respective target incremental deflection of the target space object in accordance with the collaborative deflection strategy, which results in the collaborative deflection of the target space object by the satellites achieving the target total deflection to avoid the predicted collision.

FIG. 2B shows an example 260 of collaborative deflection of a target space object 262 by a first satellite 264 and a second satellite 266 to avoid a predicted collision between the target space object 262 and another space object (not shown). The first satellite 264 and the second satellite 266 are equipped with respective electromagnetic deflector modules. Reference number 268 shows an orbital position, on an original orbital path of the target space object 262, associated with the predicted collision. As shown in example 260, the first satellite 264 deflects the target space object 262 at a first time (t1) in accordance with the collaborative deflection strategy. For example, the control system (e.g., computer 102) may control the first satellite 264 to activate the electromagnetic deflector module of the first satellite 264 at the first time (t1) to deflect the target space object 262 at the first time (t1). This results in a first incremental deflection of the target space object 262 from the original orbital path onto a deflected orbital path 270. As further shown in example 260, the second satellite 266 deflects the target space object 262 at a second time (t2) in accordance with the collaborative deflection strategy. For example, the control system (e.g., computer 102) may control the second satellite 266 to activate the electromagnetic deflector module of the second satellite 266 at the second time (t2) to deflect the target space object 262 at the second time (t2). This results in a second incremental deflection of the target space object 262. The second incremental deflection of the target space object 262 caused by the second satellite 266 is added to the first incremental deflection of the target space object 262 caused by the first satellite 264 to further increase a distance of the deflected orbital path 270 of the target space object 262 from the original orbital path of the target space object 262. The total deflection resulting from the combination of the first incremental deflection and the second incremental deflection is sufficient to cause the target space object 262 to avoid the predicted collision.

FIGS. 2A-2B are provided as an example. Other examples may differ from what is described with regard to FIGS. 2A-2B.

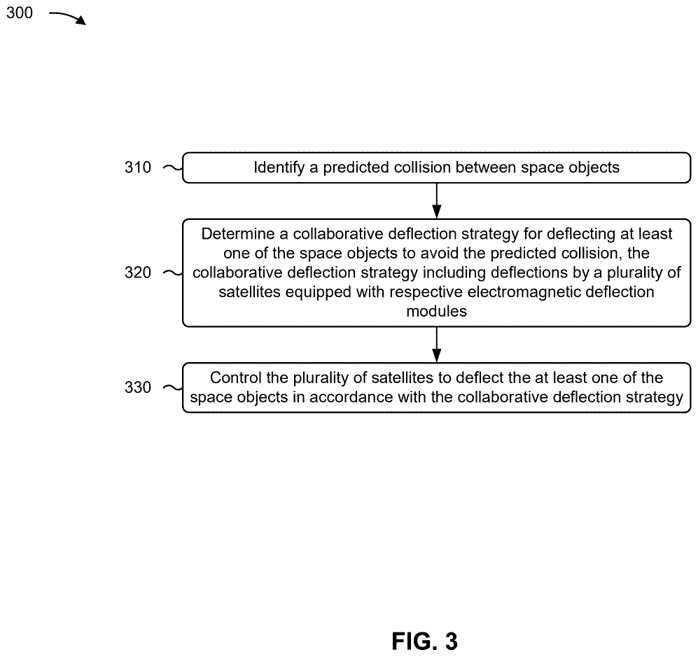

FIG. 3 is a flowchart of an example process 300 associated with collaborative controlled electromagnetic deflection of space objects. One or more process blocks of FIG. 3 are performed by a computer system (e.g., computer 102) and/or by another device or a group of devices separate from or including the computer system. Additionally, or alternatively, one or more process blocks of FIG. 3 may be performed by one or more components of computer 102, such as processor set 114, communication fabric 116, volatile memory 118, and/or space objects collision avoidance code 150.

As shown in FIG. 3, process 300 includes identifying a predicted collision between space objects (block 310). For example, the computer system may identify a predicted collision between space objects, as described above.

As further shown in FIG. 3, process 300 includes determining a collaborative deflection strategy for deflecting at least one of the space objects to avoid the predicted collision, the collaborative deflection strategy including deflections by a plurality of satellites equipped with respective electromagnetic deflection modules (block 320). For example, the computer system may determine a collaborative deflection strategy for deflecting at least one of the space objects to avoid the predicted collision, the collaborative deflection strategy including deflections by a plurality of satellites equipped with respective electromagnetic deflection modules, as described above.

As further shown in FIG. 3, process 300 includes controlling the plurality of satellites to deflect the at least one of the space objects in accordance with the collaborative deflection strategy (block 330). For example, the computer system may control the plurality of satellites to deflect the at least one of the space objects in accordance with the collaborative deflection strategy, as described above.

Process 300 may include additional aspects, such as any single aspect or any combination of aspects described below and/or in connection with one or more other processes described elsewhere herein.

In a first aspect, determining the collaborative deflection strategy includes selecting the plurality of satellites to deflect the at least one of the space objects based on relative positions of the plurality of satellites and the space objects in a simulation of orbital trajectories of the plurality of satellites and the space objects.

In a second aspect, alone or in combination with the first aspect, determining the collaborative deflection strategy includes determining a target deflection of the at least one of the space objects to avoid the predicted collision, and determining, based on the target deflection, a timing and an electromagnetic power for a respective deflection of the at least one of the space objects by each of the plurality of satellites.

In a third aspect, alone or in combination with one or more of the first and second aspects, controlling the plurality of satellites includes transmitting control signals to the plurality of satellites to activate the respective electromagnetic deflection modules of the plurality of satellites in accordance with the collaborative deflection strategy.

In a fourth aspect, alone or in combination with one or more of the first through third aspects, process 300 includes simulating of a deflection of the at least one of the space objects by the plurality of satellites in accordance with the collaborative deflection strategy.

In a fifth aspect, alone or in combination with one or more of the first through fourth aspects, simulating of the deflection of the at least one of the space objects includes simulating an effect of the deflection of the at least one of the space objects on potential collisions with other space objects.

In a sixth aspect, alone or in combination with one or more of the first through fifth aspects, identifying the predicted collision between the space objects includes simulating orbital trajectories of the space objects, and determining, based on simulating the orbital trajectories of the space objects, that a risk of a collision between the space objects satisfies a risk threshold.

In a seventh aspect, alone or in combination with one or more of the first through sixth aspects, process 300 includes selecting a collision avoidance plan that includes the collaborative deflection strategy based on at least one of a type of each of the space objects, sizes of the space objects, orbital positions of the space objects, a collision type of the predicted collision, or a cost associated with the collaborative deflection strategy.

In an eighth aspect, alone or in combination with one or more of the first through seventh aspects, selecting the collision avoidance plan includes selecting the collision avoidance plan that includes the collaborative deflection strategy based on a comparison of the cost associated with the collaborative deflection strategy and a cost associated with maneuvering one of the space objects to avoid the predicted collision.

In a ninth aspect, alone or in combination with one or more of the first through eighth aspects, the collision avoidance plan includes the collaborative deflection strategy for deflecting a first one of the space objects and a maneuvering strategy for maneuvering a second one of the space objects, and process 300 includes controlling a maneuvering module of the second one of the space objects to maneuver the second one of the space objects in accordance with the maneuvering strategy.

Although FIG. 3 shows example blocks of process 300, in some implementations, process 300 includes additional blocks, fewer blocks, different blocks, or differently arranged blocks than those depicted in FIG. 3. Additionally, or alternatively, two or more of the blocks of process 300 may be performed in parallel.

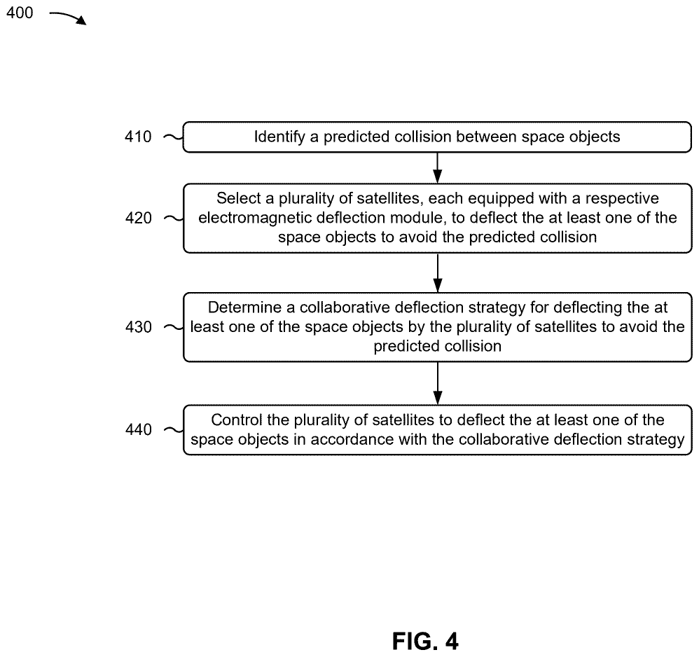

FIG. 4 is a flowchart of an example process 400 associated with collaborative controlled electromagnetic deflection of space objects. One or more process blocks of FIG. 4 are performed by a computer system (e.g., computer 102) and/or by another device or a group of devices separate from or including the computer system. Additionally, or alternatively, one or more process blocks of FIG. 4 may be performed by one or more components of computer 102, such as processor set 114, communication fabric 116, volatile memory 118, and/or space objects collision avoidance code 150.

As shown in FIG. 4, process 400 includes identifying a predicted collision between space objects (block 410). For example, the computer system may identify a predicted collision between space objects, as described above.

As further shown in FIG. 4, process 400 includes selecting a plurality of satellites, each equipped with a respective electromagnetic deflection module, to deflect the at least one of the space objects to avoid the predicted collision (block 420). For example, the computer system may select a plurality of satellites, each equipped with a respective electromagnetic deflection module, to deflect the at least one of the space objects to avoid the predicted collision, as described above.

As further shown in FIG. 4, process 400 includes determining a collaborative deflection strategy for deflecting the at least one of the space objects by the plurality of satellites to avoid the predicted collision (block 430). For example, the computer system may determine a collaborative deflection strategy for deflecting the at least one of the space objects by the plurality of satellites to avoid the predicted collision, as described above.

As further shown in FIG. 4, process 400 includes controlling the plurality of satellites to deflect the at least one of the space objects in accordance with the collaborative deflection strategy (block 440). For example, the computer system may control the plurality of satellites to deflect the at least one of the space objects in accordance with the collaborative deflection strategy, as described above.

Process 400 may include additional aspects, such as any single aspect or any combination of aspects described below and/or in connection with one or more other processes described elsewhere herein.

In a first aspect, the predicted collision is between a satellite and a piece of space debris, and the collaborative deflection strategy includes deflecting the piece of space debris by the plurality of satellites to avoid the collision.

In a second aspect, alone or in combination with the first aspect, determining the collaborative deflection strategy includes simulating a deflection of the at least one of the space objects by the plurality of satellites in accordance with the collaborative deflection strategy, and adjusting the collaborative deflection strategy based on the simulation.

In a third aspect, alone or in combination with one or more of the first and second aspects, determining the collaborative deflection strategy includes determining a total target deflection of the at least one of the space objects to avoid the predicted collision, determining, based on the total target deflection, a respective incremental target deflection associated with each of the plurality of satellites, and determining, based on the incremental target deflection associated with each of the plurality of satellites, a timing and an electromagnetic power for reflecting the at least one of the space objects by each of the plurality of satellites.

In a fourth aspect, alone or in combination with one or more of the first through third aspects, controlling the plurality of satellites includes transmitting control signals to the plurality of satellites to activate the respective electromagnetic deflection module of each of the plurality of satellites in accordance with the collaborative deflection strategy.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

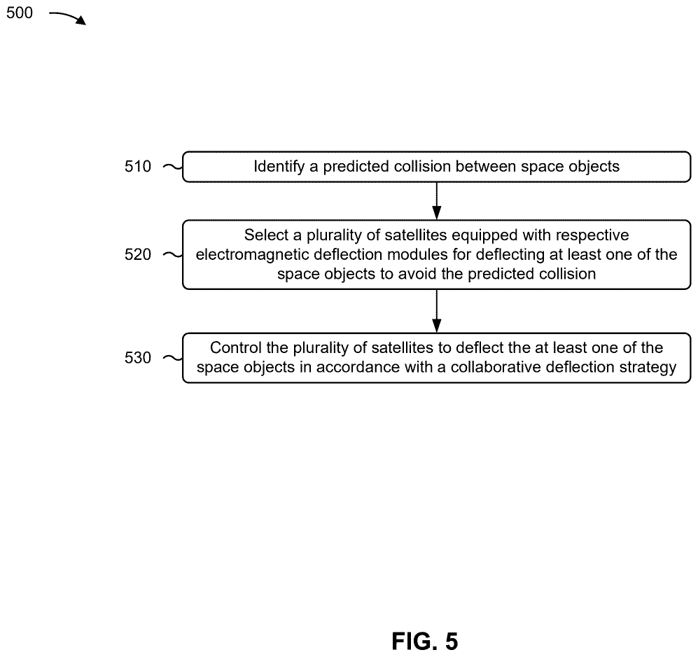

FIG. 5 is a flowchart of an example process 500 associated with collaborative controlled electromagnetic deflection of space objects. One or more process blocks of FIG. 5 are performed by a computer system (e.g., computer 102) and/or by another device or a group of devices separate from or including the computer system. Additionally, or alternatively, one or more process blocks of FIG. 5 may be performed by one or more components of computer 102, such as processor set 114, communication fabric 116, volatile memory 118, and/or space objects collision avoidance code 150.

As shown in FIG. 5, process 500 includes identifying a predicted collision between space objects (block 510). For example, the computer system may identify a predicted collision between space objects, as described above.

As further shown in FIG. 5, process 500 includes selecting a plurality of satellites equipped with respective electromagnetic deflection modules for deflecting at least one of the space objects to avoid the predicted collision (block 520). For example, the computer system may select a plurality of satellites equipped with respective electromagnetic deflection modules for deflecting at least one of the space objects to avoid the predicted collision, as described above.

As further shown in FIG. 5, process 500 includes controlling the plurality of satellites to deflect the at least one of the space objects in accordance with a collaborative deflection strategy (block 530). For example, the computer system may control the plurality of satellites to deflect the at least one of the space objects in accordance with a collaborative deflection strategy, as described above.

Process 500 may include additional aspects, such as any single aspect or any combination of aspects described below and/or in connection with one or more other processes described elsewhere herein.

In a first aspect, the collaborative deflection strategy includes a sequence of deflections by the plurality of satellites to deflect the least one of the space objects into an atmosphere of Earth.

In a second aspect, alone or in combination with the first aspect, the collaborative deflection strategy includes a sequence of deflections by the plurality of satellites to deflect the least one of the space objects out of orbit and into space.

In a third aspect, alone or in combination with one or more of the first and second aspects, selecting the plurality of satellites includes selecting a subset of a set of satellites equipped with respective electromagnetic deflection modules based on positions and electromagnetic deflection capabilities of the satellites in the set of satellites.

In a fourth aspect, alone or in combination with one or more of the first through third aspects, process 500 includes determining the collaborative deflection strategy based on a simulation of a deflection of the at least one of the space objects by the plurality of satellites.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
identifying a predicted collision between space objects;
determining a collaborative deflection strategy for deflecting at least one of the space objects to avoid the predicted collision, the collaborative deflection strategy including deflections by a plurality of satellites equipped with respective electromagnetic deflection modules; and
controlling the plurality of satellites to deflect the at least one of the space objects in accordance with the collaborative deflection strategy.

2. The method of claim 1, wherein determining the collaborative deflection strategy comprises:
selecting the plurality of satellites to deflect the at least one of the space objects based on relative positions of the plurality of satellites and the space objects in a simulation of orbital trajectories of the plurality of satellites and the space objects.

3. The method of claim 1, wherein determining the collaborative deflection strategy comprises:
determining a target deflection of the at least one of the space objects to avoid the predicted collision; and
determining, based on the target deflection, a timing and an electromagnetic power for a respective deflection of the at least one of the space objects by each of the plurality of satellites.

4. The method of claim 1, wherein controlling the plurality of satellites comprises:
transmitting control signals to the plurality of satellites to activate the respective electromagnetic deflection modules of the plurality of satellites in accordance with the collaborative deflection strategy.

5. The method of claim 1, further comprising:
simulating of a deflection of the at least one of the space objects by the plurality of satellites in accordance with the collaborative deflection strategy.

6. The method of claim 5, wherein simulating of the deflection of the at least one of the space objects comprises:
simulating an effect of the deflection of the at least one of the space objects on potential collisions with other space objects.

7. The method of claim 1, wherein identifying the predicted collision between the space objects comprises:
simulating orbital trajectories of the space objects; and
determining, based on simulating the orbital trajectories of the space objects, that a risk of a collision between the space objects satisfies a risk threshold.

8. The method of claim 1, further comprising:
selecting a collision avoidance plan that includes the collaborative deflection strategy based on at least one of a type of each of the space objects, sizes of the space objects, orbital positions of the space objects, a collision type of the predicted collision, or a cost associated with the collaborative deflection strategy.

9. The method of claim 8, wherein selecting the collision avoidance plan comprises:
selecting the collision avoidance plan that includes the collaborative deflection strategy based on a comparison of the cost associated with the collaborative deflection strategy and a cost associated with maneuvering one of the space objects to avoid the predicted collision.

10. The method of claim 8, wherein the collision avoidance plan includes the collaborative deflection strategy for deflecting a first one of the space objects and a maneuvering strategy for maneuvering a second one of the space objects, and further comprising:
controlling a maneuvering module of the second one of the space objects to maneuver the second one of the space objects in accordance with the maneuvering strategy.

11. A computer system comprising:
a processor set;
one or more computer-readable storage media;
program instructions stored on the one or more computer-readable storage media to cause the processor set to perform operations comprising:
identifying a predicted collision between space objects;
selecting a plurality of satellites, each equipped with a respective electromagnetic deflection module, to deflect the at least one of the space objects to avoid the predicted collision;
determining a collaborative deflection strategy for deflecting the at least one of the space objects by the plurality of satellites to avoid the predicted collision; and
controlling the plurality of satellites to deflect the at least one of the space objects in accordance with the collaborative deflection strategy.

12. The computer system of claim 11, wherein the predicted collision is between a satellite and a piece of space debris, and the collaborative deflection strategy includes deflecting the piece of space debris by the plurality of satellites to avoid the collision.

13. The computer system of claim 11, wherein determining the collaborative deflection strategy comprises:
simulating a deflection of the at least one of the space objects by the plurality of satellites in accordance with the collaborative deflection strategy; and
adjusting the collaborative deflection strategy based on the simulation.

14. The computer system of claim 11, wherein determining the collaborative deflection strategy comprises:
determining a total target deflection of the at least one of the space objects to avoid the predicted collision;
determining, based on the total target deflection, a respective incremental target deflection associated with each of the plurality of satellites; and
determining, based on the incremental target deflection associated with each of the plurality of satellites, a timing and an electromagnetic power for reflecting the at least one of the space objects by each of the plurality of satellites.

15. The computer system of claim 11, wherein controlling the plurality of satellites comprises:
transmitting control signals to the plurality of satellites to activate the respective electromagnetic deflection module of each of the plurality of satellites in accordance with the collaborative deflection strategy.

16. A computer program product comprising:
one or more computer-readable storage media; and
program instructions stored on the one or more computer-readable storage media to perform operations comprising:
identifying a predicted collision between space objects;
selecting a plurality of satellites equipped with respective electromagnetic deflection modules for deflecting at least one of the space objects to avoid the predicted collision; and
controlling the plurality of satellites to deflect the at least one of the space objects in accordance with a collaborative deflection strategy.

17. The computer program product of claim 16, wherein the collaborative deflection strategy includes a sequence of deflections by the plurality of satellites to deflect the least one of the space objects into an atmosphere of Earth.

18. The computer program product of claim 16, wherein the collaborative deflection strategy includes a sequence of deflections by the plurality of satellites to deflect the least one of the space objects out of orbit and into space.

19. The computer program product of claim 16, wherein selecting the plurality of satellites includes selecting a subset of a set of satellites equipped with respective electromagnetic deflection modules based on positions and electromagnetic deflection capabilities of the satellites in the set of satellites.

20. The computer program product of claim 16, wherein the operations further comprise:
determining the collaborative deflection strategy based on a simulation of a deflection of the at least one of the space objects by the plurality of satellites.
